(19) United States
(12) Patent Application Publication
(10) Pub. No.: US 2025/0155999 A1
(43) Pub. Date: May 15, 2025

(54) NEXT Hub

(71) Applicant: Keone Trask, Greenville, SC (US)

(72) Inventor: Keone Trask, Greenville, SC (US)

(21) Appl. No.: 18/944,092

(22) Filed: Nov. 12, 2024

Related U.S. Application Data
(60) Provisional application No. 63/598,350, filed on Nov. 13, 2023.

(51) Int. Cl. G06F 3/041

(52) U.S. Cl. CPC G06F 3/041

(57) ABSTRACT

An audio visual upgrade device and method of use for upgrading legacy touchscreen digital displays to the latest audio visual and computing capabilities. At least one device I/O jack is in signal communication with an integral computer and at least one display I/O jack is in signal communication with an integral computer. A multitouch module switch is provided capable of being in signal communication with a dedicated touchscreen device through the device I/O and a touchscreen digital display through the display I/O. The operating system is in signal communication with the multitouch module switch wherein the operating system converts the signal communication from the dedicated touchscreen device and from the touchscreen digital display to a touch process command. A touch process switch is provided which is capable of receiving the touch process command and transmitting the touch process command to the dedicated touchscreen device and touchscreen digital display.

### CROSS-REFERENCE TO RELATED APPLICATIONS

The present application claims priority to pending U.S. Provisional Application No. 63/598,350 filed Nov. 13, 2023, which is incorporated herein by reference.

### BACKGROUND OF THE INVENTION

The present invention generally relates to audio video devices and, more particularly, to a novel interactive hub for use with touchscreen digital displays to enhance functionality and eliminate incompatibilities as a universal upgrade device that can also function as a stand-alone audio visual and video conferencing device.

Educational institutions have transitioned over the past two generations away from chalk board use, first to marker boards and now to dedicated touchscreen devices. These touchscreen displays comprise a digital display with internal touch sensors and an on-board computer for operation.

Computers are integrated into displays in many ways to form a digital display, and for the purposes of discussion herein, a touchscreen digital display. The most common approach for integrating a computer into a digital display is by the use of a standard Intel Open Pluggable Specification (OPS) computer. OPS computers are essentially specialized computers with an external architecture designed to allow the computer itself to plug into a specifically sized receiver slot on devices such as the touchscreen displays.

Since the introduction of digital signage in the early 1990s, the market has seen rapid growth. Incorporating digital signage into a business typically requires an LCD or LED display and a media player as a basic setup. As the requirement for digital signage emerged into different markets for a wide range of applications, particularly education, a requirement for a standardization of hardware was required to simplify new and expanding digital signage infrastructure. Intel OPS, or just OPS, was commercialized around 2010 as the standard for digital signage infrastructure.

The Intel OPS is now believed by many to be the industry standard for connecting new media players into all forms of digital displays via universal internal slot. This standard eliminates the need for specific cables and an open pluggable specification computer is simply inserted into a single slot of any OPS compatible display to create an all-in-one digital signage or touchscreen solution wherein the image manipulation taking place on the touch screen device can be passed through the OPS for simultaneous display on a display screen.

With advancements in technology, the Intel OPS+ standard enables a broader range of Intel processors to be integrated, including Intel Xeon processors, and Intel Field Programmable Gate Array (FPGA). Intel OPS+ can also support 8K resolution displays or the ability to drive three separate 4K resolution displays.

A particular advantage is the use of standard connectors in OPS computers such as a single 80-pin connector that carries all necessary communication and power between the OPS and display. Communication not only includes the video display and audio, but data from the accessible input/output (I/O) ports. With a uniform housing, this 80-pin connector provides a simple integration into the display for seamless transmission of the screen image to the digital signage display. OPS+ media players also feature a secondary high-speed connector to future-proof Intel's OPS solution and allow for the higher-resolution content.

While this uniform standard allows many types of computers to be used in many types of digital displays, it also creates some problems for manufacturers. Touchscreen displays can last as long as 15 years, while their onboard OPS computers tend to last only 3 years. This means that computer upgrades are not only possible but often preferred, rather than replacing the entire touchscreen. A problem arises when a manufacturer wishes to protect the user experience, which may be based on a specific set of functions and applications unique to its touchscreens and/or computer.

No prior art systems are available to upgrade existing legacy touchscreen digital displays, for example, to give them the full capabilities of current audio visual and video conferencing systems now used in most corporate and educational facilities. This deficiency arises from multiple issues encountered with attempting to connect a full audio visual and video conferencing suite to many legacy touchscreen digital displays because of the lack of similar standards and interoperability. The touchscreen input-output formats, for example, are so numerous that prior art systems have been unable to provide a single device for this purpose. What is needed is a complete upgrade system that will allow a user to quickly connect a single device to a legacy touchscreen digital display that will then upgrade that legacy touchscreen digital display to provide the full suite of capabilities including, at least, a high-quality sound bar, a microphone, a high resolution camera, a state of the art computer that is compatible with all current audio visual and video conferencing systems. What is needed is a hub that is fully backwards compatible with all types of touchscreen input-output formats found on legacy touchscreen digital displays.

Many problems exist with creation of such an upgrade hub. A particular problem arises with the advent of touchscreen digital displays wherein the touchscreen digital display itself has touchscreen capabilities as does an external dedicated touchscreen device, such as a personal computer, interfaced to the touchscreen digital display. A particular application wherein this is important is in the field of education wherein sight impaired students, for example, can utilize a dedicated touchscreen device wherein the dedicated touchscreen device needs to be mimicked on the larger touchscreen digital display visible to others in the teaching environment. Transmission of the image and sound from the dedicated touchscreen device to the larger touchscreen digital display is not possible with prior art systems using standard OPS for image manipulation on the touchscreen to pass back through the operating system to the dedicated touchscreen device. Current architecture is not compatible with simultaneous interfacing.

The reason for the incompatibility is illustrated schematically in FIG. 1 wherein the architecture is represented in flow chart representation. In FIG. 1, a dedicated touchscreen device, 10, is in signal communication with a firm ware driver module, 12, of a conventional hub, 11. The appropriate driver for the dedicated touchscreen device is resident in the firm ware driver module. The signal is converted to process commands, in accordance with the firmware driver, and transmitted to a touch process module, 14, which creates a touch process command. The touch process command is transmitted to the output driver, 16, to provide an image command which is relayed to the touchscreen digital display, 20, through a touch out port, 18, for display on the touchscreen digital display. Image manipulation on the touchscreen digital device is not rearward compatible and therefore any activity related to touch commands on the touchscreen digital display is not visible on the dedicated touchscreen device.

The problem of incompatibility is exasperated by the large number of available touchscreen digital displays and, more particularly, the rapid growth in the number of touch points available with touchscreen digital displays. The firmware of the touchscreen digital display architecture, particularly the firm ware driver module, is required to analyze the touch point data from every interactive flat panel (IFP) and adapt it according to the driver of the dedicated touchscreen device. This adapted information must then be sent the modified touch data through the touch out port. It is very difficult for every IFP to be analyzed and implemented. Every combination of dedicated touchscreen device and touchscreen digital display would require a unique solution making both the manufacturer of the touchscreen digital display and the manufacturer of the dedicated touchscreen device to be subservient to each other which severely limits compatibility with currently existing technology and curtails independent development of improved systems.

The instant invention provides a unique architecture which allows for compatibility of image transfer between a dedicated touchscreen device and a touchscreen digital display without regards to differences in the operating system and system requirements implemented in both.

The instant invention also provides a fully-backwards-compatible upgrade device that can be connected to all legacy touchscreen digital displays. In this way, the Next Hub easily converts a simple touchscreen display with an outdated computer—lacking any video conferencing and Wi-Fi capabilities—into a fully functional touchscreen digital display with a video camera, microphone, soundbar, modern computer with update capability and a full suite of software to operate in any boardroom or classroom. This avoids the need to fully replace entire legacy touchscreen digital displays.

### SUMMARY OF THE INVENTION

The present invention (the “NEXT” hub) provides a unified communications video bar for use in upgrading a wide variety of older touchscreen displays. The invention comprises a modern computer that functions with every known feature of current touchscreen display devices including, without limitation, video, audio, microphone, and all common input output ports.

A preferred embodiment of the invention has the chipset, software, and EDLA Android 13 ecosystem of 6000A+ panels. This means older touchscreens panels can get a software update, OS update, and feature set upgrade all within a device that will be cheaper than a replacement. It will also save on E-waste/disposal costs of old technology.

More specifically, the invention includes a 6000A+ series computer that is capable of operation with all modern audio and video devices. It further includes a 4k camera and a 6-array microphone to provide state of the art video capabilities for any touchscreen.

Since many older touchscreen, and even newer ones, use small internal speakers that provide low-volume, low-fidelity output, the invention provides high-fidelity, high-volume amplifiers and speakers for clarity in both the classroom and boardroom.

The invention can be mounted on any existing touchscreen device in 15 minutes or less, cutting down the time and expertise needed for typical upgrades. To install, a user simply places the invention on the top of the touchscreen, plugs in an HDMI, USB, or other cable as needed.

To provide further functionality, the invention even allows connection of the OPS computer from the panel, or a separate laptop. In this way, all former and current computing functionality is provided through the invention. For example, when connected in this manner, the invention allows for screen capturing, annotation, and touchscreen capability, using the existing glass screen, but all managed by the upgraded computer in the invention.

One of the primary advantages provided by the invention is remote learning. Both classrooms and boardrooms alike learned during the covid pandemic that remote learning is essential is today's society. The invention upgrades any touchscreen to provide a modern audio/visual learning experience, without the poor audio, video, computing, and connectivity issues experienced by many during the pandemic.

Another advantage of the invention is its cost savings, compared to complete replacement of existing touchscreens. Most estimates indicate that the invention provides at least a twenty percent savings, while simultaneously cutting down on unnecessary waste and the costs of disposal, which typically runs at least $400.

Another advantage of the invention is that it provides the latest software suite to all users. Prior art touchscreens typically did not provide for software upgrades and, when they did, the upgrades were time-consuming and cumbersome. The invention is Internet connected and allows for seamless upgrades.

Yet another advantage of the invention is its small size. Typically measuring only 25×4×4 inches, it can be placed in a suitcase for travel and then connected to any available video screen upon arrival, avoiding the need for shipment of a modern touchscreen, while simultaneously providing users the latest audio/video capabilities while traveling.

Another advantage of the invention is that it allows for use of the NEXT microphone, which provides exceptional audio/video connectivity and clarity in both boardrooms and classrooms.

Another advantage of the invention is that it is fully EDLA-certified in both the chips and firmware. This provides a google-certified system that is far more secure. It also provides access to the google play store, more application compatibility, and management by google admin.

The present invention also provides an interface between a dedicated touchscreen device, such as a personal computer or the like, and a touchscreen digital display wherein touchscreen commands on one are displayed on the other.

A particular advantage is the ability to provide upgrades to any touchscreen to provide a modern audio/visual learning experience, with superior audio, video, computing, and connectivity.

Another advantage of the invention is cost savings, particularly when compared to complete replacement of existing touchscreens.

Another advantage of the invention is the ability to utilize updated or revised software without regards for compatibility of the hardware.

Yet another advantage of the invention is its small size.

Another advantage of the invention is that it allows for use of the NEXT microphone, which provides exceptional audio/video connectivity and clarity in both boardrooms and classrooms.

Another advantage of the invention is that it is fully EDLA-certified in both the chip and firmware. This provides a google-certified system that is far more secure. It also provides access to the google play store, more application compatibility, and management by google admin.

A particular advantage of the invention is provided by a NEXT Hub. The NEXT Hub comprises an integral computer comprising an operating system in functional control of the integral computer, at least one device I/O jack capable of receiving incoming signal communication from said integral computer and at least one display I/O jack capable of sending outgoing signal communication to said integral computer. A multitouch module switch is provided which is capable of being in signal communication with the device I/O and the display I/O. The operating system is capable of receiving a touch communication from the multitouch module switch and the operating system converts the touch communication to a touch process command.

A touch process switch is capable of receiving the touch process command and transmitting the touch process command to the display I/O or the device I/O.

Yet another embodiment is provided in a NEXT Hub. The NEXT Hub comprises an integral computer comprising an operating system in functional control of the integral computer, at least one device I/O jack capable of receiving signal communication of the integral computer and at least one display I/O jack capable of sending signal communication to the integral computer. A multitouch module switch is provided which is capable of being in signal communication with the device I/O and the display I/O. The operating system is capable of receiving a touch communication from the multitouch module switch and the operating system converts the touch communication to a touch process command. A touch process switch is provided which is capable of receiving the touch process command and transmitting the touch process command to the display I/O or device I/O. The NEXT Hub provides for integration and upgrade of legacy touchscreen displays by using existing touch process inputs and outputs of one or more of a multiplicity of legacy touchscreen digital displays of varying manufacture and design.

Yet another advantage is provided in a method of interfacing a dedicated touchscreen device and a touchscreen digital display comprising: providing a NEXT Hub comprising: an integral computer comprising an operating system in functional control of said integral computer; at least one device I/O jack capable of receiving signal communication with the integral computer; at least one display I/O jack capable of sending signal communication with the integral computer; a multitouch module switch capable of being in signal communication with at least one of a device I/O or a display I/O; wherein the operating system is capable of receiving a touch communication from the multitouch module switch wherein the operating system converts the touch communication to a touch process command; and a touch process switch capable of receiving the touch process command and transmitting the touch process command to at least one of the display I/O or the device I/O.

Yet another advantage of the invention is provided in a NEXT Hub. The NEXT Hub comprises an integral computer comprising an operating system in functional control of the integral computer. At least one device I/O jack is in signal communication with the integral computer and at least one display I/O jack is in signal communication with the integral computer. A multitouch module switch is provided which is capable of being in signal communication with a dedicated touchscreen device through the device I/O and a touchscreen digital display through the display I/O. The operating system is in signal communication with the multitouch module switch wherein the operating system converts the signal communication from the dedicated touchscreen device and from the touchscreen digital display to a touch process command. A touch process switch is provided which is capable of receiving the touch process command and transmitting the touch process command to the dedicated touchscreen device and touchscreen digital display.

Yet another embodiment is provided in a method of interfacing a dedicated touchscreen device and a touchscreen digital display. The method comprises: providing a NEXT Hub comprising: an integral computer comprising with an operating system in functional control of the integral computer; at least one device I/O jack in signal communication with the integral computer; at least one display I/O jack in signal communication with said integral computer; a multitouch module switch capable of being in signal communication with a dedicated touchscreen device through said device I/O and a touchscreen digital display through said display I/O; wherein said operating system is in signal communication with said multitouch module switch wherein said operating system converts said signal communication from said dedicated touchscreen device and from said touchscreen digital display to a touch process command; and a touch process switch capable of receiving said touch process command and transmitting said touch process command to said dedicated touchscreen device and said touchscreen digital display; connecting said dedicated touchscreen device to a device I/O of said at least one device I/O; and connecting said touchscreen digital display to a display I/O of said at least one display I/O.

### BRIEF DESCRIPTION OF THE DRAWINGS

FIG. 1 is a flow-chart representation of the prior art.

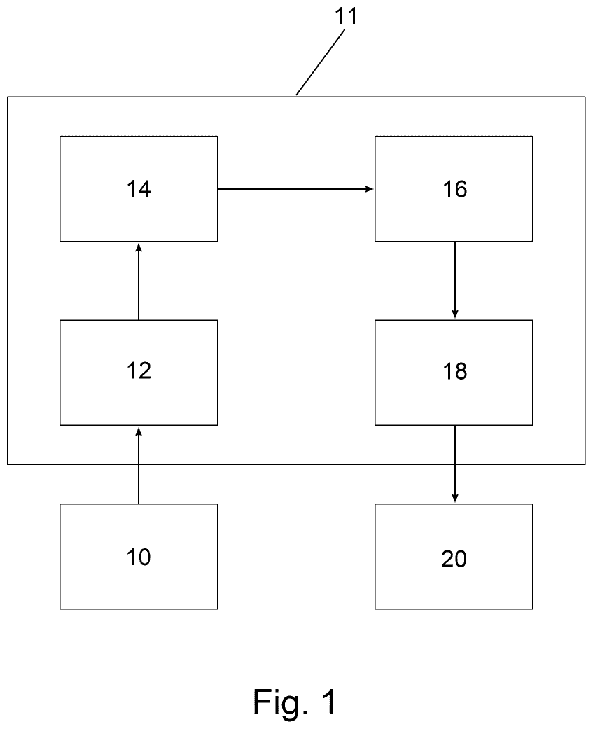

FIG. 2 is a schematic representation of an embodiment of the invention.

FIG. 3 is a flow-chart representation of an embodiment of the invention.

FIG. 4 is a flow-chart representation of an embodiment of the invention.

FIG. 5 is a flow-chart representation of an embodiment of the invention.

### DESCRIPTION OF THE PREFERRED EMBODIMENTS

The present invention is a NEXT Hub that functions as an interface between a dedicated touchscreen device, such as a personal computer or the like, and a touchscreen digital display wherein touchscreen commands on one are displayed on the other. More specifically, the present invention is specific to a NEXT Hub which facilitates upgrades and interface between dedicated touchscreen devices and touchscreen digital displays without complications related to incompatibility associated with hardware and software incorporated in the dedicated touchscreen device and a touchscreen digital display.

The present invention provides a unified communications video bar for use in upgrading a wide variety of older touchscreen displays. The invention comprises a modern on-board chip that functions with every known feature of current touchscreen display devices including, without limitation, video, audio, microphone, and all common input/output ports.

The invention will be described with reference to the figures which are an integral part of the instant disclosure provided for clarification of the description of the invention without limit thereto. As appropriate, similar elements will be numbered accordingly.

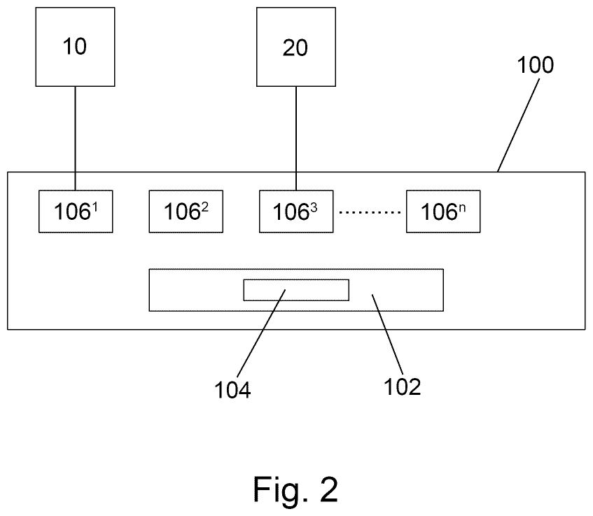

An embodiment of the invention is illustrated in schematic view in FIG. 2. In FIG. 2, the NEXT hub, 100, comprises an integral computer, 102, with an operating system, 104, in functional control of the integral computer. Input/Output (I/O) jacks, 106, are in signal communication with the integral computer wherein each I/O jack is capable of signal communication with at least one dedicated touchscreen device, 10, and at least one touchstone digital display, 20. Though not limited thereto, I/O jacks in signal communication with the dedicated touchscreen device are referred to as device I/O jacks and I/O jacks in signal communication with the touchscreen digital display are referred to as display I/O jacks for the purposes of clarity of discussion.

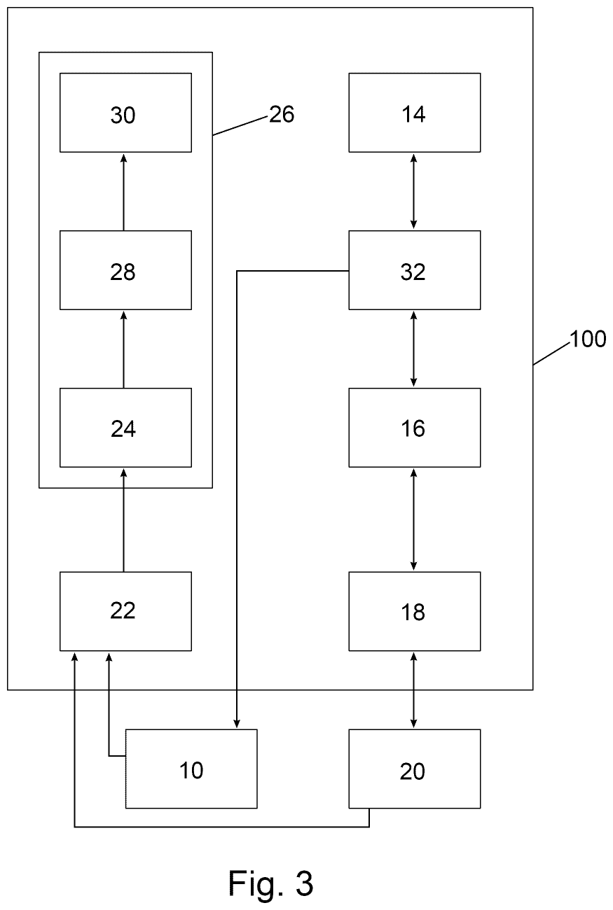

An embodiment of the invention will be described with reference to FIG. 3 wherein the architecture of the NEXT Hub, 100, is illustrated in a flow chart representation. In FIG. 3, the dedicated touchscreen device, 10, is in signal communication, preferably touch communication, with a multitouch module switch, 22. As will be realized the multitouch module allows for multiple inputs from different sources. The multitouch module switch is in signal communication, preferably touch communication, with the input system, 24, of the an integral computer comprising the operating system, 26. As would be realized the input system of the operating system has integral therewith an input reader, 28, and dispatch module, 30, which provides signal output to the touch process module, 14. The touch process module creates a touch process command which is transmitted to a touch process switch, 32. The touch process command is transmitted to the dedicated touchscreen device, 10, and to the output driver, 16, for simultaneous display of the same image on the dedicated touchscreen device and the touchscreen digital display through the touch- out port, 18. Signal communication can include audio, video or image control commands. Touch communication is signal communication comprising touch commands from a digital touch device such as a dedicated touchscreen device or a touchscreen digital display.

With further refence to FIG. 3, in a parallel process the touchscreen digital display is also in signal communication with the multitouch module switch, 22, which is in signal communication with the operating system, 26, of the display computer. As would be realized from the discussion herein, the operating system, 26, allows any device which is compatible with the operating system to interface with any other compatible device. By switching the signal input at the multitouch module switch, 22, and the touch process switch, 32, the results of touch commands can be simultaneously manipulated by touch command on either the dedicated touchscreen device or the touchscreen digital device and displayed on both simultaneously.

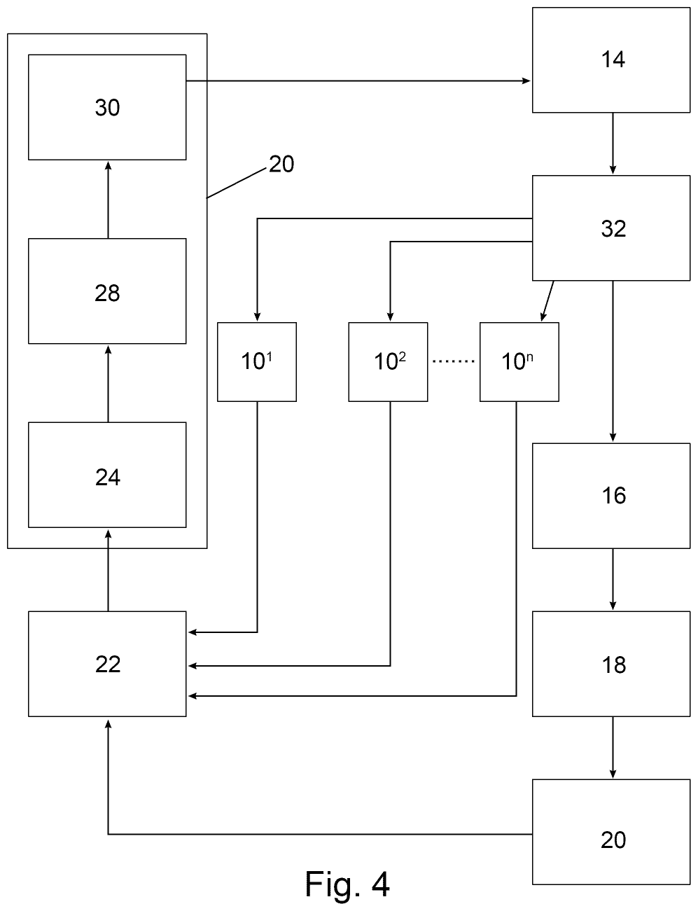

An embodiment of the invention is illustrated schematically in FIG. 4 wherein multiple dedicated touchscreen devices, 10¹-10ⁿ, are illustrated. The number of dedicated touchscreen devices, represented by superscript n, is not particularly limited by the invention but only by the availability of dedicated touchscreen devices and switch capacity.

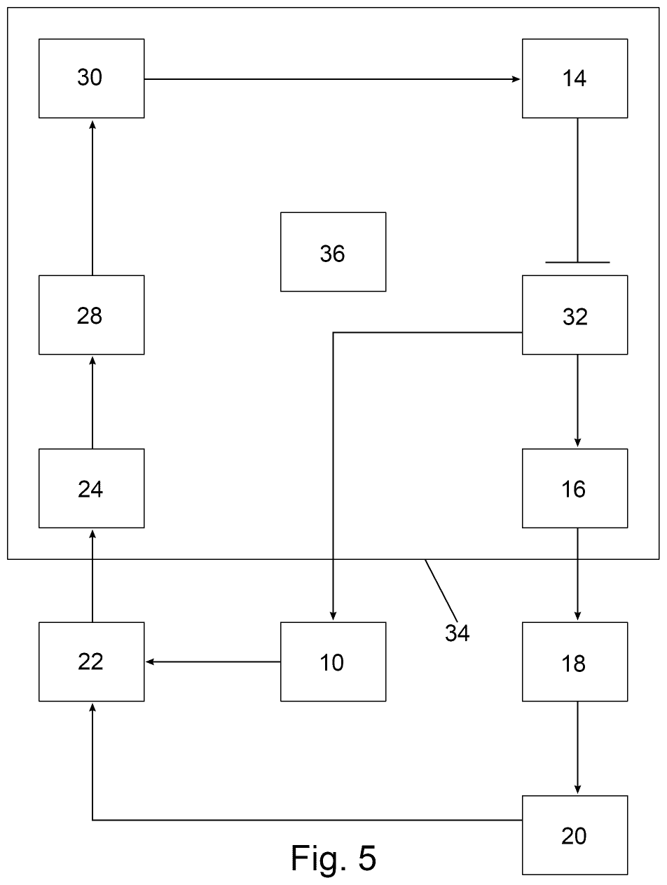

An embodiment of the invention is illustrated schematically in FIG. 5. In FIG. 5 an additional layer of the operating system, 34, comprises an application, 36, wherein the application, referred to in the art as an app, allows for additional functionality on the touchscreen digital display. Layered architecture, the implementation of which is well known in the art, allows for the use of tools include screensharing, annotation, screenshot capabilities, interactive lessons, device management, and collaborating work.

The integral computer of the NEXT Hub preferably includes a 6000A+ series on-board chip that is capable of operation with all modern audio and video devices. A particularly preferred embodiment comprises a 4k camera and a 6-array microphone to provide state of the art video capabilities for any touchscreen.

A particular advantage of the invention is the ability to utilize different operating systems. Preferred operating systems include Windows loaded on the Intel Pluggable Specification (OPS), Smart Display Module (SDM), macOS or ChromeOS. Most preferably the operating system is Windows loaded on the Intel Pluggable Specification (OPS).

The NEXT Hub preferably comprises speakers thereby allowing full functionality as a sound bar. Most preferred are high-fidelity, high-volume amplifiers and speakers which provide clarity in larger environments such as those common in classrooms and boardrooms. Speakers which are 6-array speakers are preferable. Speakers coupled with an audio amplifier of at least 15 watts are preferable.

Connectivity is not particularly limited by the invention. Particularly preferred are USB-A, USB-C, HDMI, VGA and other conventional cables due to widespread availability.

To provide further functionality, the invention even allows connection of the OPS computer from the panel, or a separate laptop. In this way, all former and current computing functionality is provided through the invention. For example, when connected in this manner, the invention allows for screen capturing, annotation, and touchscreen capability, using the existing glass screen, but all managed by the upgraded computer in the invention.

In a preferred embodiment, the NEXT Hub utilizes the chipset, software, and EDLA Android 13 ecosystem of 6000A+ panels. This means older touchscreens panels can get a software update, OS update, and feature set upgrade all within a device that far more economical than a replacement. It will also save on E-waste/disposal costs of old technology. Particularly preferred chips for interface with touchscreen devices are RK3588 available commercially from Rockchip Electronics Co. LTD.

The invention provides the latest software suite to all users. Prior art touchscreens typically did not provide for software upgrades and, when they did, the upgrades were time-consuming and cumbersome. The NEXT Hub is Internet connected and allows for seamless upgrades.

The shape and size of the inventive NEXT Hub is not particularly limited with the exception of having sufficient size to allow for the desired number of I/O jacks and, if employed, sufficient facial area for speaker performance. A particular embodiment is sufficiently small to fit into a conventional suitcase for travel. This allows the NEXT Hub to be mobile and connectible to any available video screen upon arrival, avoiding the need for shipment of a modern touchscreen, while simultaneously providing users the latest audio/video capabilities while traveling.

The present invention is compatible with Enterprise Device Licensing Agreement (EDLA) certification requirement which allows for 16 points of touch. EDLA is a collaboration between Google and Android developers to certify a device according to a set of standards. Achieving EDLA has become a standard in and of itself for the IFP industry allowing for the panels to have a complete review by a third party. EDLA certification of the invention allows older touchsource digital displays to be updated to a newer operating system, such as Android OS without prior vulnerabilities.

A touchscreen display manufacturer may provide many proprietary applications and functions that require a specific match between hardware and software, so they design and manufacture their own OPS computers to maximize the functionality of their touchscreens. If a user were to upgrade with a generic OPS computer, the result may be reduced functionality or even complete system failure due to mismatched hardware and software. Unscrupulous users may even upgrade a touchscreen display with a faster but less compatible computer and then attempt to pass it off as a newer model for sale.

In some cases, therefore, the solution is to upgrade the computer using a proprietary adapter to install a new OPS computer. But, where the touchscreen is very old or simply has little to no functionality beyond the glass itself, simply upgrading the computer only provides part of the solution.

Touch points are the number of touch points a screen can recognize simultaneously. A single touch point, for example, would only allow for simple control such as tap, scroll or swipe using a single stylus or finger, for example. With more simultaneous touch points more complex actions can be used such as multiple-finger scrolling, multiple finger expand or zoom, and more complex actions involving multiple fingers, or stylus points, on the screen simultaneously. The number of touch points is not particularly limited herein with the understanding that advances in the number of touch points on a screen will likely continue to grow and therefore the instant invention allows compatibility with increased touch points which was previous difficult to provide.

Elements of the invention not otherwise specified are well known in the art and not necessarily limited herein including memory storage, touch screen technology, power systems and the like. A particular feature of the instant invention is the ability to interface and function with any system compatible with the generic operating system used such as Intel OPS.

The invention has been described with reference to the preferred embodiments without limit thereto. Those of skill in the art may realize additional improvements and embodiments which are not specifically stated but which are within the scope of the invention as set forth in the claims appended hereto.

1. A NEXT Hub comprising:
an integral computer comprising an operating system in functional control of said integral computer;
at least one device I/O jack capable of receiving incoming signal communication from said integral computer;
at least one display I/O jack capable of sending outgoing signal communication to said integral computer;
a multitouch module switch capable of being in signal communication with said device I/O and said display I/O;
wherein said operating system is capable of receiving a touch communication from said multitouch module switch and wherein said operating system converts said touch communication to a touch process command; and
a touch process switch capable of receiving said touch process command and transmitting said touch process command to said display I/O or said device I/O.

2. The NEXT Hub of claim 1 further comprising a digital touch device in signal communication with at least one of said display I/O or said device I/O.

3. The NEXT Hub of claim 1 wherein said digital touch device is a touchscreen digital display.

4. The NEXT Hub of claim 1 wherein said digital touch device is a dedicated touchscreen device.

5. The NEXT Hub of claim 1 wherein said operating system is selected from the group consisting of Intel Pluggable Specification and Smart Display Module.

6. The NEXT Hub of claim 5 wherein said operating system is Intel Pluggable Specification.

7. The NEXT Hub of claim 1 wherein said operating system further comprising an application layer.

8. The NEXT Hub of claim 7 wherein said application layer is selected from the group consisting of screensharing, annotation, screenshot, interactive lessons, device management, and collaborating work.

9. The NEXT Hub of claim 1 comprising a series 6000A+ chip.

10. The NEXT Hub of claim 1 wherein at least one of said device I/O or said display I/O is a connected selected from the group consisting of USB-A, USB-C, HDMI and VGA.

11. The NEXT Hub of claim 1 comprising at least one of a speaker and a video camera.

12. A NEXT Hub comprising:
an integral computer comprising an operating system in functional control of said integral computer;
at least one device I/O jack capable of receiving signal communication with said integral computer;
at least one display I/O jack capable of sending signal communication with said integral computer;
a multitouch module switch capable of being in signal communication with said device I/O and said display I/O;
wherein said operating system is capable of receiving a touch communication from said multitouch module switch and wherein said operating system converts said touch communication to a touch process command;
a touch process switch capable of receiving said touch process command and transmitting said touch process command to said display I/O or said device I/O; and
wherein said NEXT Hub provides for upgrade of legacy touchscreen digital displays by using existing touch process inputs and outputs of said legacy touchscreen digital displays.

13. The NEXT Hub of claim 12 further comprising a digital touch device in signal communication with at least one of said display I/O or said device I/O.

14. The NEXT Hub of claim 12 wherein said digital touch device is a touchscreen digital display.

15. The NEXT Hub of claim 12 wherein said digital touch device is a dedicated touchscreen device.

16. The NEXT Hub of claim 12 wherein said operating system is selected from the group consisting of Intel Pluggable Specification and Smart Display Module.

17. The NEXT Hub of claim 16 wherein said operating system is Intel Pluggable Specification.

18. The NEXT Hub of claim 12 wherein said operating system further comprising an application layer.

19. The NEXT Hub of claim 18 wherein said application layer is selected from the group consisting of screensharing, annotation and screenshot.

20. The NEXT Hub of claim 12 comprising a series 6000A+ chip.

21. The NEXT Hub of claim 12 wherein at least one of said device I/O or said display I/O is a connected selected from the group consisting of USB-A, USB-C, HDMI and VGA.

22. The NEXT Hub of claim 12 comprising at least one of a speaker and a video camera.

23. A NEXT Hub comprising:
an integral computer comprising an operating system in functional control of said integral computer;
at least one device I/O jack in signal communication with said integral computer;
at least one display I/O jack in signal communication with said integral computer;
a multitouch module switch capable of being in signal communication with a dedicated touchscreen device through said device I/O and a touchscreen digital display through said display I/O;
wherein said operating system is in signal communication with said multitouch module switch wherein said operating system converts said signal communication from said dedicated touchscreen device and from said touchscreen digital display to a touch process command; and
a touch process switch capable of receiving said touch process command and transmitting said touch process command to said dedicated touchscreen device and said touchscreen digital display.

24. The NEXT Hub of claim 23 wherein said operating system is selected from the group consisting of Intel Pluggable Specification, Smart Display Module, macOS and ChromeOS.

25. The NEXT Hub of claim 24 wherein said operating system is Intel Pluggable Specification.

26. The NEXT Hub of claim 23 wherein said operating system further comprising an application layer.

27. The NEXT Hub of claim 26 wherein said application layer is selected from the group consisting of screensharing, annotation and screenshot.

28. The NEXT Hub of claim 23 comprising a series 6000A+ chip.

29. The NEXT Hub of claim 23 wherein at least one of said device I/O or said display I/O is a connected selected from the group consisting of USB-A, USB-C, HDMI and VGA.

30. The NEXT Hub of claim 23 comprising at least one of a speaker and a video camera.

31. A method of interfacing a dedicated touchscreen device and a touchscreen digital display comprising:
providing a NEXT Hub comprising:
an integral computer comprising an operating system in functional control of said integral computer;
at least one device I/O jack capable of receiving signal communication with said integral computer;
at least one display I/O jack capable of sending signal communication with said integral computer;
a multitouch module switch capable of being in signal communication with at least one of said device I/O or said display I/O;
wherein said operating system is capable of receiving a touch communication from said multitouch module switch wherein said operating system converts said touch communication to a touch process command; and
a touch process switch capable of receiving said touch process command and transmitting said touch process command to at least one of said display I/O or said device I/O.

32. The method of interfacing a dedicated touchscreen device and a touchscreen digital display of claim 31 further comprising a digital touch device in signal communication with at least one of said display I/O or said device I/O.

33. The method of interfacing a dedicated touchscreen device and a touchscreen digital display of claim 31 wherein said digital touch device is a touchscreen digital display.

34. The method of interfacing a dedicated touchscreen device and a touchscreen digital display of claim 31 wherein said digital touch device is a dedicated touchscreen device.

35. The method of interfacing a dedicated touchscreen device and a touchscreen digital display of claim 31 wherein said operating system is selected from the group consisting of Intel Pluggable Specification, Smart Display Module, macOS and ChromeOS.

36. The method of interfacing a dedicated touchscreen device and a touchscreen digital display of claim 31 wherein said operating system is Intel Pluggable Specification.

37. The method of interfacing a dedicated touchscreen device and a touchscreen digital display of claim 31 wherein said operating system further comprising an application layer.

38. The method of interfacing a dedicated touchscreen device and a touchscreen digital display of claim 37 wherein said application layer is selected from the group consisting of screensharing, annotation and screenshot.

39. The method of interfacing a dedicated touchscreen device and a touchscreen digital display of claim 31 comprising a series 6000A+ chip.

40. The method of interfacing a dedicated touchscreen device and a touchscreen digital display of claim 31 wherein at least one of said device I/O or said display I/O is a connected selected from the group consisting of USB-A, USB-C, HDMI and VGA.

41. The method of interfacing a dedicated touchscreen device and a touchscreen digital display of claim 31 comprising at least one of a speaker and a video camera.

42. A method of interfacing a dedicated touchscreen device and a touchscreen digital display comprising:
providing a NEXT Hub comprising:
an integral computer comprising with an operating system in functional control of said integral computer;
at least one device I/O jack in signal communication with said integral computer;
at least one display I/O jack in signal communication with said integral computer;
a multitouch module switch capable of being in signal communication with a dedicated touchscreen device through said device I/O and a touchscreen digital display through said display I/O;
wherein said operating system is in signal communication with said multitouch module switch wherein said operating system converts said signal communication from said dedicated touchscreen device and from said touchscreen digital display to a touch process command; and
a touch process switch capable of receiving said touch process command and transmitting said touch process command to said dedicated touchscreen device and said touchscreen digital display;
connecting said dedicated touchscreen device to a device I/O of said at least one device I/O; and
connecting said touchscreen digital display to a display I/O of said at least one display I/O.

43. The method of interfacing a dedicated touchscreen device and a touchscreen digital display of claim 42 wherein said operating system is selected from the group consisting of Intel Pluggable Specification, Smart Display Module, macOS and ChromeOS.

44. The method of interfacing a dedicated touchscreen device and a touchscreen digital display of claim 43 wherein said operating system is Intel Pluggable Specification.

45. The method of interfacing a dedicated touchscreen device and a touchscreen digital display of claim 42 wherein said operating system further comprising an application layer.

46. The method of interfacing a dedicated touchscreen device and a touchscreen digital display of claim 45 wherein said application layer is selected from the group consisting of screensharing, annotation and screenshot.

47. The method of interfacing a dedicated touchscreen device and a touchscreen digital display of claim 42 comprising a series 6000A+ chip.

48. The method of interfacing a dedicated touchscreen device and a touchscreen digital display of claim 42 wherein at least one of said device I/O or said display I/O is a connected selected from the group consisting of USB-A, USB-C, HDMI and VGA.

49. The method of interfacing a dedicated touchscreen device and a touchscreen digital display of claim 42 comprising at least one of a speaker and a video camera.
